(19) United States
(12) Patent Application Publication
(10) Pub. No.: US 2022/0398256 A1
(43) Pub. Date: Dec. 15, 2022

(54) DECENTRALIZED INFORMATION SYSTEM AND METHOD

(71) Applicant: Christopher Hartline, Chesapeake, VA (US)

(72) Inventor: Christopher Hartline, Chesapeake, VA (US)

(21) Appl. No.: 17/752,162

(22) Filed: May 24, 2022

Related U.S. Application Data
(60) Provisional application No. 63/210,120, filed on Jun. 14, 2021.

(51) Int. Cl. G06F 16/27; G06F 16/23

(52) U.S. Cl. CPC G06F 16/27; G06F 16/2379; H04W 84/18

(57) ABSTRACT

A decentralized information system may include a plurality of nodes that are in electronic communication and may include a first primary node operable by a first user, a second primary node operable by a second user, and a secondary node, and the secondary node may be an unmanned sensor that is configured to record sensor data. The system may also include a plurality of decentralized applications, with each decentralized application running on at least one node. Preferably, each node of the plurality of nodes is running one decentralized application of the plurality of decentralized applications. A distributed ledger may be used to confirm and catalog data for the decentralized applications. At least one message data may be generated by the first primary node and addressed to the second primary node, the message data added to the distributed ledger via a consensus mechanism performed by the decentralized applications.

### CROSS REFERENCE TO RELATED APPLICATIONS

This application claims priority to and the benefit of the filing date of U.S. Provisional Application No. 63/210,120, filed on Jun. 14, 2021, entitled “EMPLOYMENT OF DECENTRALIZED LEDGER TECHNOLOGY AND “EXPONENTIAL TECHNOLOGIES” SUCH AS EDGE COMPUTING FOR MISSION COMMAND AND MISSION CRITICAL INFORMATION SYSTEMS”, which is hereby incorporated by reference in its entirety.

### FIELD OF THE INVENTION

The present invention relates to the fields of communications, command and control (C2) systems and digital mission systems. The present invention employs “exponential technologies” such as distributed ledger technology, edge computing, solar power and the Internet of Things (IoT) to provide an assured, secure system for operational, mission command and mission critical information systems.

### BACKGROUND

Contemporary communication systems are closed and centralized, designed complete as-is. Many of these systems are decades old, burdened by design decisions made in the 1980s and 1990s. These systems are closed: the notion of an open system is a contemporary concept. Concepts such as Service Oriented Architectures (SOA) were created in an effort to enable modularity and interoperability, to make systems more open once it was determined that additional value could be gained through their integration. These systems are centralized: their operation depends on a single node—a mainframe, a database, a server or a service delivery point. These systems are complete: they fulfill all identified requirements, operate as-is, as initially deployed.

At the beginning of the 21^{st} century growing digitization and the availability of broadband networks increased the need to integrate disparate systems. This is when the military became interested in concepts such as “network centric warfare”, the ability to link “sensors” to “shooters”, enabling decisive operations through improved command and control (C2) delivered by battle command information systems (i.e., C2 systems, C4ISR systems, Mission Command Information Systems, (digital) Mission Systems). The Army's concept for the Future Combat System (FCS) arrived at the pinnacle of this hype-cycle. Unfortunately, it was a concept whose (technical) time had yet to come. While the FCS program was canceled numerous capabilities were spun-out (e.g., the Force XXI Battle Command Brigade and Below (FBCB2)). Some of these technologies immediately rolled into fielded platforms (e.g., M1A2 SEP (System Enhancement Package)). Others did not.

In the United States the strategic reality, namely conflicts in Afghanistan and Iraq, required a shift towards other concepts and technologies (e.g., counter-LED, Counter Insurgency (COIN)), shelving the likes of “Network Centric Operations” and “Effects Based Operations”.

Concepts and capabilities are developed around expected operating conditions. This is as true in the military as it is in commercial IT. Specialized information systems, mission command systems, were complete when initially fielded whether that was 1977 or 2007. These systems were designed around operating concepts, tied to specific needs and operational requirements. In their day many of these systems were pioneers in the field. They represented the cutting-edge in computing, networking and systems engineering. These systems have been updated, partially refactored, integrated into a system-of-systems. This integration enabled data sharing and increased the total capability of the composed system of systems. This integration enabled ground maneuver systems to exchange data with artillery fire direction systems.

The operation of centralized, ruggedized IT systems within tactical units comes with significant challenges. Within these systems client applications running on ruggedized laptops, workstations or tablets have to communicate with servers and centralized databases. Data frames are switched through the local area networks (LAN), exiting gateways (i.e., routers) before being encapsulated into data packets destined for the Wide Area Network (WAN), likely transmitted through high-power radio or satellite links. This is not ideal for military operations, especially in contemporary times. These systems require significant power, routine maintenance and are exceptionally susceptible to attack because of their visible signature in the physical and cyber realm. They are commercial IT systems, ruggedized for operations in an austere environment. Put another way the corporate data center is operating in a tent. Attempts to distribute or establish redundant communication nodes is helpful; but these attempts do not address reality. These information systems are centralized by design, built around decades old architectural standards that are unfitting for the contemporary environment.

Updating these systems is a challenge for a multitude of reasons. First, collectively these systems represent a significant sunk cost. Since they are considered weapons systems, the military has no reason not to consider a twenty-year Return on Investment (ROI). If an information system (i.e., C2 or mission system) is considered a weapon system and a weapon system lasts for decades then transitive logic indicates that an information system should last for decades too. A few examples: the Air Force's C-130 was designed in the 1950s; the Army's M1 main battle tank was designed in the early 1970s. IT advances way too fast for programs to reasonably expect a 20, 10, or even 5-year ROI. Second, these systems are tied to multiple programs and contracts, impossible to unravel or align programmatically. Third, from an architectural standpoint since all of the information systems are themselves individual systems there is no true foundation for mature interoperability unless it was designed into all of the systems at the beginning. Dozens of Ph.D. dissertations attribute this fact. Today information is shared across these centralized system of systems but only because middleware spans the gap between them. What is more, the centralized nature demands significant effort be placed on establishing trust within the network. Fourth, over the last thirty years military operations have required the systems to work ‘now.’ As a result, major advances in information technology (IT) were rarely rolled into these programs. Military operations in Afghanistan and Iraq began in 2002 and 2003, respectively. Over that period of time there was never an opportune time to overhaul or completely refresh and replace the aging, deployed information systems. Fifth, concepts and technologies were focused on executing existing processes faster. Simply automating processes speed things up. This automation initially led to what has been referred to as infoglut, the inability to identify meaningful information in a flood of data. In the years following the initiation of OPERATION: Iraqi Freedom (OIF) these systems were upgraded, largely through improvements to usability or because of advances to the underlying commercial IT systems (e.g., server hardware, network speed). In 2015 the Army set out to address some of the architectural issues through the establishment of the Common Operating Environment and numerous associated Computing Environment reference architectures. The COE is meant to provide standards and processes for the common. The associated CEs reference architectures constrain design but go a long way to ensure conformance within the to-be system of system's operating environment. While an integrated design is a step in the right direction it still does nothing to address survivability and sustainability concerns attributable to the operation of a centralized data center in the field. In other words, future command posts will continue to be centralized, high-value targets that require significant support and employment consideration.

The previous paragraphs identified how design considerations in the 1970s, 1980s and 1990s continue to impact contemporary C2 (i.e., mission command systems) information systems. They also described the risk attributed to these systems because of their centralized nature and operational value. We concluded with how twenty years ‘in the field’ has stifled innovation and precluded any attempt to address these issues in a significant way. Finally, we concluded with a discussion on how contemporary efforts fail to address the real issue, namely that centralized C2 is inherently risky.

Therefore, a need exists for novel secure information systems which may be used for national security implementation, and in other sectors including law enforcement, emergency response or even as the basis for a public decentralized, IT fabric. A further need exists for novel secure information systems that do not rely on a small number of centralized, commercial service providers whose business-model requires that they generate profits for their shareholders.

### BRIEF SUMMARY OF THE INVENTION

A computer-implemented decentralized information system and method are provided which may be configured for employing exponential technologies in mission information systems—harnessing distributed ledger technology, such as blockchain, along with emerging solar and power technologies and edge computing to create a decentralized secure communications, operations and mission command system. In preferred embodiments, the decentralized information system may employ a blockchain (e.g., HyperLedger Fabric) distributed ledger along with edge computing, advanced wireless networking and emerging power generation and storage capabilities (e.g., solar cells and graphene batteries) to provide the foundation for a decentralized, IoT-like, mission information system. In further preferred embodiments, the decentralized information system may employ a Directed Acyclic Graph (DAG) distributed ledger along with edge computing, advanced wireless networking and emerging power generation and storage capabilities (e.g., solar cells and graphene batteries) to provide the foundation for a decentralized, IoT-like, mission information system.

In some embodiments, the decentralized information system may include a plurality of nodes that are in electronic communication. The plurality of nodes may include one or more, and more preferably a plurality of primary nodes and secondary nodes. The plurality of nodes may also include a first primary node operable by a first user, a second primary node operable by a second user, and a secondary node, and the secondary node may be or may be in communication with an unmanned sensor that is configured to record sensor data. The system may also include one or more, and more preferably, a plurality of decentralized applications, with each decentralized application running on at least one node. Preferably, each node of the plurality of nodes is running one decentralized application of the plurality of decentralized applications. A distributed ledger may be used to confirm and catalog data for the decentralized applications. At least one message data may be generated by the first primary node and addressed to the second primary node, the message data added to the distributed ledger via a consensus mechanism performed by the decentralized applications.

In further embodiments, the distributed ledger may be a blockchain distributed ledger that may use blockchain protocols and consensus mechanisms.

In further embodiments, the distributed ledger may be a distributed acyclic graph (DAG) distributed ledger that may use distributed acyclic graph protocols and consensus mechanisms.

In some embodiments, a decentralized information method may include the steps of: receiving message data from user input of a first user via a first primary node, the message data addressed to a second primary node of a second user; receiving receive sensor data via a secondary node; communicating message data and/or sensor data to a distributed ledger network; adding message data and/or sensor data to distributed ledger via a consensus mechanism; and retrieving the message data and/or sensor data from distributed ledger via second primary node.

Numerous objects, features and advantages of the present invention will be readily apparent to those of ordinary skill in the art. One object of the present invention is to provide a novel system and method which swaps the centralized service provider of existing communication systems for an encrypted, decentralized or distributed ledger. As an example, the encrypted messages created from user input, node and sensor data, etc., may be appended to a blockchain type of distributed ledger. Once the block is full, it is hashed, providing nonrepudiation. Anyone that attempts to alter the messages will have to break the chain and insert new data. That activity will be immediately noticed by all nodes as hash values will not be equivalent. Preferred embodiments may use a permissioned blockchain or permissioned DAG to provide additional security and speed transactions while reducing the computation load of the software on the nodes. In existing systems, having a client-server architecture that employs a centralized service provider for numerous clients, a message, an email for example, is likely stored within a server with recipients receiving a pointer to the message, not the entire message until it is downloaded by the client application. The message will exist on the centralized server. Organizations employing these existing systems go to great financial lengths, infrastructure lengths, etc., to harden this service, to provide redundancy and resilience.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a decentralized information system according to various embodiments described herein.

FIG. 2 illustrates a block diagram showing an example of a network configured as a mesh network which may be used by the system as described in various embodiments herein.

FIG. 3 shows a block diagram illustrating an example of a node that is configured as a primary node which may be used by the system as described in various embodiments herein.

FIG. 4 depicts a block diagram illustrating an example of a node that is configured as a secondary node which may be used by the system as described in various embodiments herein.

FIG. 5 illustrates a block diagram depicting an example of a controller of a node which may be used by the system as described in various embodiments herein.

FIG. 6 shows a block diagram illustrating some applications which may function as software rules engines and some software components of a decentralized information system according to various embodiments described herein.

FIG. 7 depicts a block diagram of some of the various example (software) layers used in HyperLedger Fabric (HLF) distributed ledger according to various embodiments described herein.

FIG. 8 illustrates a block diagram of an example of a computer-implemented decentralized information method according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the term “computer” refers to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “node” as used herein is a type of computer comprising circuitry and configured to generally perform one or more functions, such as recording audio, photos, and videos; displaying or reproducing audio, photos, and videos; storing, retrieving, or manipulation of electronic data; providing electrical communications and network connectivity; or any other similar function. Non-limiting examples of nodes include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of nodes which are portable and easily carried by a person from one location to another may sometimes be referred to as a “portable node” or “portable device”. Some non-limiting examples of portable nodes include: cell phones, smartphones, tablet computers, laptop computers, wearable computers such as Apple Watch, other smartwatches, Fitbit, other wearable fitness trackers, Google Glasses, and the like. Additionally, nodes may be dedicated or specialized contracted hardware, such as which may be used by armed forces, police, national guard, coast guard, etc.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e., a “wireless network”) which may include Wi-Fi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e., information and data from a database may be recorded into a medium on a data store).

As used herein, the term “distributed ledger” shall generally mean a distributed database that maintains a continuously growing ledger or list of records, secured from tampering and revision using hashes, such as a blockchain database, Directed Acyclic Graph (DAG), etc. In a blockchain type of distributed ledger, every time data may be published to a distributed database the data may be published as a new block. Each block may include a timestamp and a link to a previous block. A directed acyclic graph type of distributed ledger has vertices and edges. Thus, crypto transactions are recorded as vertices. These transactions are then recorded on top of one another. Through the use of a peer-to-peer network and a distributed timestamping server, a distributed database is managed autonomously. A distributed database may be an open, distributed ledger that can record transactions between two parties efficiently and in a verifiable and permanent way. Consensus ensures that the shared ledgers are exact copies, and lowers the risk of fraudulent transactions, because tampering would have to occur across many places at exactly the same time. Cryptographic hashes, such as the SHA256 computational algorithm, ensure that any alteration to transaction input results in a different hash value being computed, which indicates potentially compromised transaction input. Digital signatures ensure that transactions originated from senders (signed with private keys) and not imposters. This covers different approaches to the processing including hash trees and hash graphs. At its core, a distributed database system records the chronological order of transactions with all nodes agreeing to the validity of transactions using the chosen consensus model. The result is transactions that are irreversible and agreed to by all members in the network.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new computer-implemented decentralized information system and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

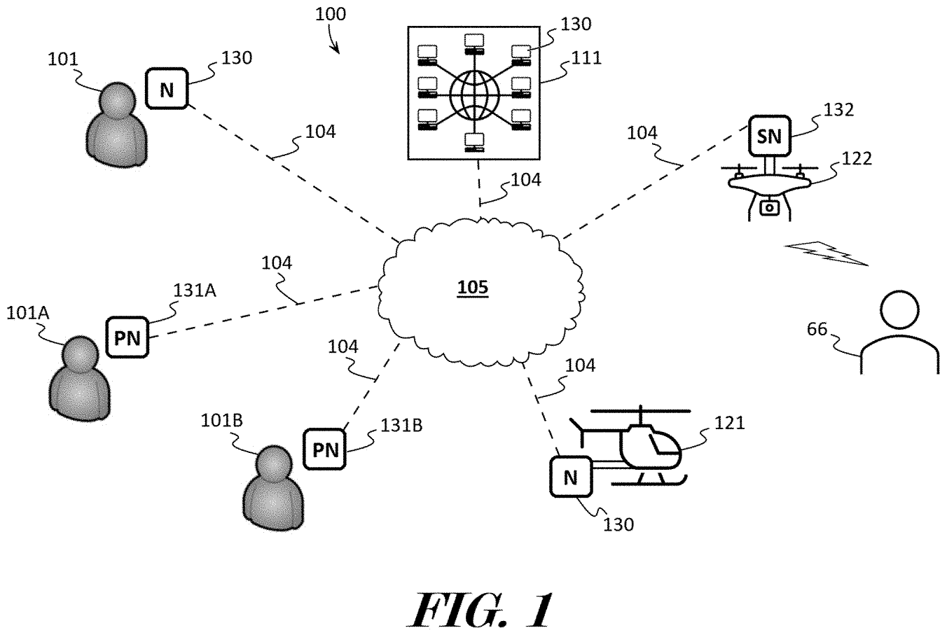

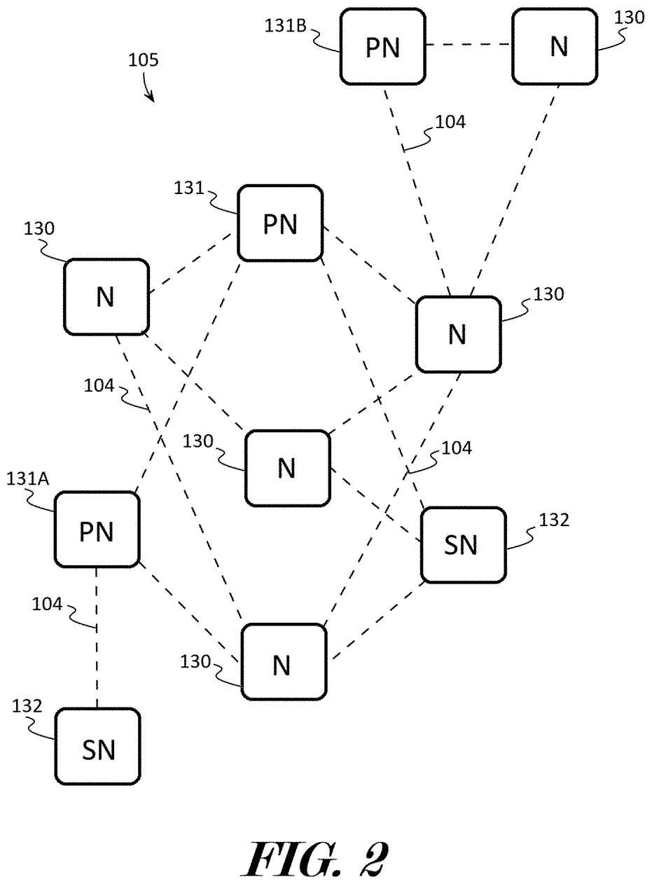

The present invention will now be described by example and through referencing the appended figures representing preferred and alternative embodiments. As perhaps best shown by FIGS. 1 and 2, illustrative examples of some of the physical components which may comprise a decentralized information system (“the system”) 100 according to some embodiments are presented. The system 100 is configured to facilitate the transfer of data and information between one or more nodes 130, 131, 132, over a data network 105. Each node 130, 131, 132, may send data to and receive data from the data network 105 through a network connection 104 with one or more other nodes 130, 131, 132. In preferred embodiments, the system 100 may comprise one or more nodes 130 which may include one or more primary nodes 131 and one or more secondary nodes 132. In some embodiments, a primary node 131 may be distinguished from a secondary node 132 by primary nodes 131 having greater computing power than secondary nodes 132; by primary nodes 131 being used to receive data input and provide system 100 data output to a user 101; and/or by secondary nodes 132 being integrated in unmanned assets, such as a navigation beacon, part of an unmanned sensor 122, unmanned drone, unmanned vehicle, etc.

In preferred embodiments, a data network 105 may comprise a mesh network (as perhaps best shown in FIG. 2). A mesh network is a local network topology in which the infrastructure nodes (i.e., bridges, switches, and other infrastructure devices) connect directly, dynamically and non-hierarchically to as many other nodes as possible and cooperate with one another to efficiently route data to and from clients. This lack of dependency on one node allows for every node to participate in the relay of information. Mesh networks dynamically self-organize and self-configure, which can reduce installation overhead. The ability to self-configure enables dynamic distribution of workloads, particularly in the event a few nodes should fail. This in turn contributes to fault-tolerance and reduced maintenance costs. Mesh topology may be contrasted with conventional star/tree local network topologies in which the bridges/switches are directly linked to only a small subset of other bridges/switches, and the links between these infrastructure neighbors are hierarchical. Mesh networks enable information through a peer-to-peer relationship, where every node 130, 131, 132, is capable of communicating with every other node 130, 131, 132. Again, this is the opposite of current systems that route traffic across a centralized, hub-and-spoke WAN. In the system 100 of the present invention, users 101, sensors, automation and service principals, can exchange information without an intermediary. As an example, a manned vehicle 121 that employs these methods to send an encrypted message with sensor data to a base station many miles away.

In this example, the system 100 comprises a plurality of nodes 130, 131, 132. Optionally, a node 130, 131, 132, may be configured to be operated by one or more users 101 or a node 130, 131, 132, be configured to operate autonomously. Nodes 130, 131, 132, can be mobile devices, such as laptops, tablet computers, personal digital assistants, smart phones, and the like, that are equipped with a wireless network interface capable of sending data to one or more other nodes 130, 131, 132, of the system 100 over a network 105 such as a wireless local area network (WLAN). Additionally, nodes 130, 131, 132, can be fixed devices, such as desktops, workstations, and the like, that are equipped with a wireless or wired network interface capable of sending data to one or more other nodes 130, 131, 132, of the system 100 over a wireless or wired local area network 105. The present invention may be implemented using at least one node 130, 131, 132, programmed to perform one or more of the steps described herein. In preferred embodiments, more than one node 130, 131, 132, may be programmed to carry out one or more steps of a method or process described herein.

In some embodiments, the system 100 may include or be in communication with a distributed ledger network 111 with a plurality of nodes 130, 131, 132, forming the distributed ledger network 111 and maintaining a distributed ledger 112, 113, stored thereon, and with a plurality of nodes 130, 131, 132, having access to the distributed ledger 112, 113. The distributed ledger network 111 may manage the distributed ledger 112, 113, containing data recorded by the one or more nodes 130, 131, 132, of the system 100. The data recorded by the one or more nodes 130, 131, 132, of the distributed ledger 112, 113, may be maintained as a continuously growing ledger or listing of the data, which may be referred to as blocks, secured from tampering and revision. Each block includes a timestamp and a link to a previous block. Through the use of a peer-to-peer distributed ledger network 111 and a distributed timestamping node 130, 131, 132, a distributed ledger 112, 113, may be managed autonomously. Consensus ensures that the shared ledgers are exact copies, and lowers the risk of fraudulent transactions, because tampering would have to occur across many places at exactly the same time. Cryptographic hashes, such as the SHA256 computational algorithm, ensure that any alteration to transaction data input results in a different hash value being computed, which indicates potentially compromised transaction input. Digital signatures ensure that data entry transactions (data added to the distributed ledger 112, 113,) originated from senders (signed with private keys) and not imposters. At its core, a distributed ledger 112, 113, may record the chronological order of data entry transactions with all nodes 130, 131, 132, agreeing to the validity of entry transactions using a chosen consensus model, such as roof-of-work (PoW), proof-of-stake (PoS), Proof of Capacity (PoC), Proof of Activity (PoA), Proof of Authority (PoA), Proof of Burn (PoB), Proof of History (PoH), Proof of Elapsed Time (PoET), Delegated Proof of Stake (DPoS), It Takes Two To Tangle (IOTA), etc. The result is data entry transactions that are irreversible and agreed to by all members in the distributed ledger network 111.

The distributed ledger network 111 may comprise a cryptocurrency or digital asset designed to work as a medium of exchange that uses cryptography to secure its transactions, to control the creation of additional units, and to verify the transfer of assets. Example cryptocurrencies include Bitcoin, Ether, Ripple, etc. The distributed ledger network 111 may also comprise tokens common to cryptocurrency based distributed ledger networks 111. The tokens may serve as a reward or incentive to nodes 112 for distributed ledger network 111 services and to make the distributed ledger network 111 attack resistant. The distributed ledger network 111 may comprise token governance rulesets based on crypto economic incentive mechanisms that determine under which circumstances distributed ledger network 111 transactions are validated and new blocks are created. Tokens may include usage tokens, utility token, work tokens, behavioral tokens, Intrinsic, Native or Built-in tokens, application token, asset-backed tokens, or any other type of token which may be used in a cryptocurrency network.

In some embodiments, the system 100 may comprise a blockchain distributed ledger 112 that may use a blockchain protocol for data storage and other functions. In further embodiments, the system 100 may comprise a directed acyclic graph distributed ledger 113 that may use a directed acyclic graph (DAG) protocol for data storage and other functions. A directed acyclic graph or DAG is a data modeling or structuring tool typically used in cryptocurrencies. Unlike a blockchain, which consists of blocks, directed acyclic graphs have vertices and edges. Thus, crypto transactions are recorded as vertices. These transactions are then recorded on top of one another. Similar to a blockchain, however, transactions are also submitted to the DAG via nodes 130, 131, 132. Proof-of-work (PoW) tasks are required of nodes 130, 131, 132, to submit a transaction.

FIG. 1 shows a schematic diagram of some components of the system 100. The system 100 may enable a plurality of users 101, such as a first user 101A and a second user 101B, to read and write to a distributed ledger 112, 113, via a node 130, 131, 132, that they are operating according to their roles. Nodes 130 of the system 100 may also be integrated into one or more manned vehicles 121 and/or unmanned vehicles 122, thereby allowing the system 100 to include the one or more manned vehicles 121 (e.g., a helicopter, truck, tank, etc.) and/or unmanned vehicles 122 (e.g., a drone). Decentralized applications (dApp) running on the plurality of nodes 130, 131, 132, may be employed to interact with data and other users (via their respective nodes 130, 131, 132) and for interacting with the distributed ledger (e.g., the blockchain, DAG, etc.).

In existing systems, a message, an email for example, is likely stored within a server with recipients receiving a pointer to the message, not the entire message until it is downloaded by the client application. The message will exist on the centralized server. Risk management is outside the scope of this invention but suffice to say organizations go to great lengths to harden this service, to provide redundancy and resilience. This is an exemplary client-server architecture that employs a centralized service provider for numerous clients. However, the system 100 of the present invention swaps the centralized service provider for an encrypted, decentralized or distributed ledger 112, 113. As an example, the encrypted messages created from user 101 input, node 130, 131, 132, sensor data, etc., are appended to a blockchain type of distributed ledger 112. Once the block is full, it is hashed, providing nonrepudiation. Anyone that attempts to alter the messages will have to break the chain and insert new data. That activity will be immediately noticed by all nodes 130, 131, 132, as hash values will not be equivalent. Preferred embodiments may use a permissioned blockchain or permissioned DAG to provide additional security and speed transactions while reducing the computation load of the software on the nodes 130, 131, 132.

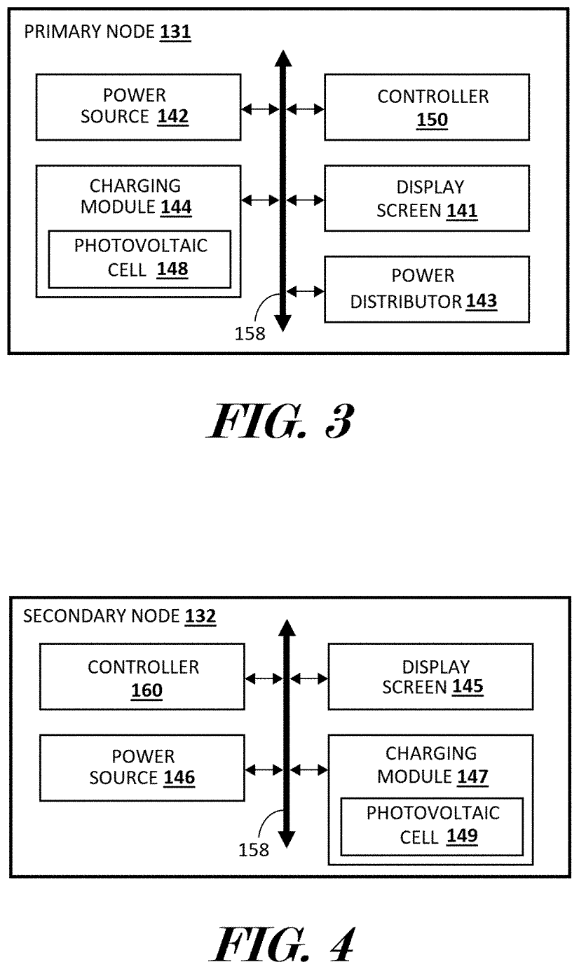

Referring now to FIGS. 3-6, some exemplary components of a node 130, such as a primary node 131 and a secondary node 132, are illustrated, each of which may be any type of computing platform. Primary nodes 131 and secondary nodes 132 may be a digital computer that, in terms of hardware architecture, generally each include a controller 150, 160, and one or more of: a processor 151, input/output (I/O) interfaces 152, a network interface, preferably having a radio 153, a data store 154, and memory 155.

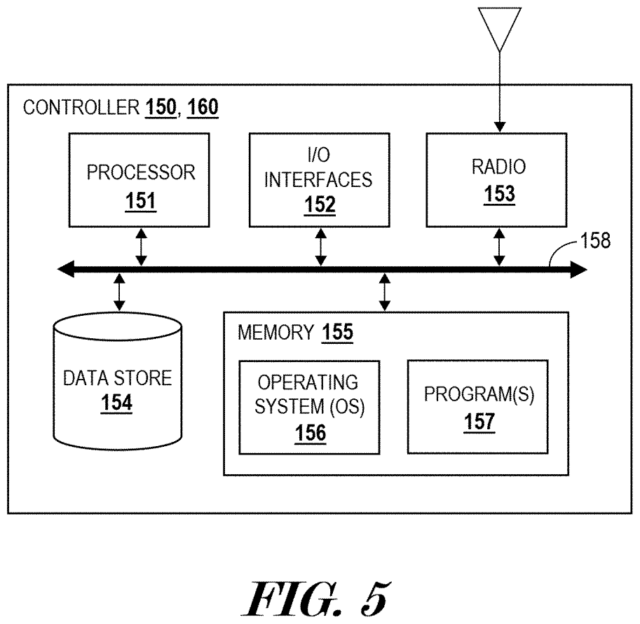

It should be appreciated by those of ordinary skill in the art that FIG. 5 depicts a controller 150, 160, in an oversimplified manner, and a practical embodiment may include additional components and suitably configured processing logic to support known or conventional operating features that are not described in detail herein.

The components (151, 152, 153, 154, and 155) are communicatively coupled via a local interface 158. The local interface 158 may be, for example but not limited to, one or more buses or other wired or wireless connections, as is known in the art. The local interface 158 may have additional elements, which are omitted for simplicity, such as controllers, buffers (caches), drivers, repeaters, and receivers, among many others, to enable communications. Further, the local interface 158 may include address, control, and/or data connections to enable appropriate communications among the aforementioned components.

The processor 151 is a hardware device for executing software instructions. The processor 151 can be any custom made or commercially available processor, a central processing unit (CPU), a processor among several processors, a semiconductor-based microprocessor (in the form of a microchip or chip set), or generally any device for executing software instructions. When a node 130, 131, 132, is in operation, the processor 151 is configured to execute software stored within the memory 155, to communicate data to and from the memory 155, and to generally control operations of the node 130, 131, 132, pursuant to the software instructions. In an exemplary embodiment, the processor 151 may include a mobile optimized processor such as optimized for power consumption and mobile applications. In some embodiments, a node 130, such as a primary node 131 and a secondary node 132, may be a single-board computer (SBC). A single-board computer is a complete computer built on a single circuit board, with microprocessor 151, memory 155, input/output 152, and other features required of a functional computer. In preferred embodiments, a processor 151 may comprise a single board computer, such as a Raspberry Pi 4, BeagleBone Black, Nvidia Jetson Nano, etc., which are as capable as many laptops, and more capable than aged desktops. In fact, the Jetson Nano includes a Graphic Processing Unit (GPU) and is capable of running AI tests. In further embodiments, a node 130, such as a primary node 131 and a secondary node 132, may be a computer that contains separated processor 151, data store 154, and/or memory 155, such that one or more components (151, 152, 153, 154, and 155) may be separated or discrete from each other.

The I/O interfaces 152 can be used to receive data and user input and/or for providing system output. User input can be provided via a plurality of I/O interfaces 152, such as a keypad, a touch screen, a camera, a microphone, a scroll ball, a scroll bar, buttons, barcode scanner, voice recognition, eye gesture, and the like. System output can be provided via a display screen 141, 145, such as a liquid crystal display (LCD), touch screen, and the like. The I/O interfaces 152 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 152 can include a graphical user interface (GUI) that enables a user to interact with the node 130, 131, 132. Additionally, the I/O interfaces 152 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 153 enables wireless communication to an external access device or network. Any number of suitable wireless data communication protocols, techniques, or methodologies can be supported by the radio 153, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

In preferred embodiments, nodes 130, 131, 132, may comprise radios 153 which may enable the nodes 130, 131, 132, to be in electronic communication via one or more of: Wi-Fi communication methods and protocols; LoRa communication methods and protocols; and 5G wireless communication methods and protocols, although other wireless communication methods and protocols may be used. Low frequency, Very Low Frequency and Extremely Low Frequency radio can be used to communicate around the globe. In preferred embodiments, the system may be optimized for LoRA because of its range and efficiency. LoRa is a radio modulation technique that is essentially a way of manipulating radio waves to encode information using a chirped (chirp spread spectrum technology), multi-symbol format. LoRaWAN is a low-power, wide area networking protocol built on top of the LoRa radio modulation technique. It wirelessly connects devices to the internet and manages communication between end-node devices and network gateways. Preferably, at least two nodes 130, 131, 132, of the plurality of nodes of the system 100 may be in electronic communication using one or more LoRa wireless communication methods and protocols.

In some embodiments, nodes 130, 131, 132, may communicate via 5G and/or follow-on extensions or enhancements to the base system may use 5G. 5G is the fifth-generation technology standard for broadband cellular networks. As a transport mechanism, 5G would have more than enough bandwidth but it comes with limited range. Preferably, at least two nodes 130, 131, 132, of the plurality of nodes of the system 100 may be in electronic communication using one or more 5G wireless communication methods and protocols. In further embodiments, nodes 130, 131, 132, of the system 100 may use other network technology including satellite communications, such as those offered by Starlink, although the system 100 may be configured to use any alternate mechanisms for information exchange at regional and global distances. In further embodiments, the system 100 may use clustered compute modules and solar power along with other elements and functions of the system 100 to provide networked, ‘free compute’.

The data store 154 may be used to store data and is therefore a type of memory. The data store 154 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 155 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 155 may incorporate electronic, magnetic, optical, and/or other types of storage media. Note that the memory 155 may have a distributed architecture, where various components are situated remotely from one another, but can be accessed by the processor 151. The software in memory 155 can include one or more software programs 157, each of which includes an ordered listing of executable instructions for implementing logical functions. In the example of FIG. 5, the software in the memory system 155 includes a suitable operating system (O/S) 156 and programs 157.

The operating system 156 essentially controls the execution of other computer programs, and provides scheduling, input-output control, file and data management, memory management, and communication control and related services. The operating system 156 may be, for example, LINUX (or another UNIX variant), Android (available from Google), Symbian OS, Microsoft Windows CE, Microsoft Windows 7 Mobile, Microsoft Windows 10, Microsoft Windows 11, iOS (available from Apple, Inc.), webOS (available from Hewlett Packard), Raspbian OS (available from Raspberry foundation), Blackberry OS (Available from Research in Motion), and the like.

The programs 157 preferably may include a communication engine 170, and a decentralized application 180, and various applications, add-ons, etc. configured to provide end user functionality with the node 130, 131, 132. For example, exemplary programs 157 may include, but not limited to, a web browser, social networking applications, streaming media applications, games, mapping and location applications, electronic mail applications, financial applications, and the like. In a typical example, the end user typically uses one or more of the programs 157 along with a network 105 to manipulate information of the system 100.

Nodes 130, 131, 132, may comprise any suitable computing platform having a controller 150, 160. In some embodiments, a node 130 may be powerful as a desktop computer and may be referred to as a primary node 131. In preferred embodiments, a primary node 131 is configured for operation by a human user 101, much like a radio, or alternatively an embedded system. As technology matures, a primary node 131 may be integrated into a professional or personal protective equipment (PPE), possibly even into an everyday carry device (EDC) or even clothing.

In some embodiments, and as shown in FIG. 3, a primary node 131 may comprise a controller 150, a display screen 141, a power source 142, a power distributor 143, and a charging module 144 with one or more local interfaces 158 providing communication between these elements. For example, a primary node 131 may comprise a controller 150 that may be a Raspberry Pi 4.

In some embodiments, a node 130 may be a secondary node 132 that optionally may comprise a relatively less powerful computing platform than a primary node 131 and may comprise a IoT sensor, possibly used to ‘seed’ a much larger parallel compute, blockchain or DAG fabric. In some embodiments, a secondary node 132 may be used as or configured as a navigation point or beacon, as part of an unmanned sensor, etc. In further embodiments, a secondary node 132 may comprise a Pi Zero, a Jetson Nano in order to provide an AI-enabled sensor on the distributed ledger network 111, etc.

In some embodiments, and as shown in FIG. 4, a secondary node 132 may comprise a controller 160, a display screen 145, a power source 146, and a charging module 147 with one or more local interfaces 158 providing communication between these elements. For example, a secondary node 132 may comprise a controller 160 that may be a Raspberry Pi Zero (W).

In preferred embodiments, a node 130, such as a primary 131 and a secondary node 132, may include a display screen 141, 145, which may be configured to visually output or display information to a user 101. Preferably, a display screen 141, 145, may comprise efficient micro displays that may be employed to provide users a visual interface. For example, a primary node 131 may have a display screen 141 that comprises an Ingcool 7-inch HDMI LCD (capacitive touch), and a secondary node 132 may have a display screen 145 that comprises a Waveshare 2.9-inch E-paper display. These display screens 141, 145, may be integrated with other emerging capabilities like the Integrated Visual Augmentation System (IVAS). In this case the data of the system 100 may be output to IVAS, such as through an HDMI, or other suitable connector. In this case the peripheral (e.g., IVAS) may have its own power supply by design so display and power consumption associated with the display 141, 145, could be offloaded to IVAS. In further embodiments, a display screen 141, 145, may comprise a light emitting device such as a light-emitting diode (LED). In still further embodiments, a display screen 141, 145, may comprise a Liquid crystal display (LCD), Light-emitting diode display (LED), Electroluminescent display (ELD), Electronic paper, E Ink, Plasma display panel (PDP), Cathode ray tube display (CRT), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), and/or any other device or method which may be configured to provide visual information to a user and optionally to receive input from a user such as a touch screen display. There are numerous vendors that make miniature displays for Pi-like devices that may be used as a display screen 141, 145. In preferred embodiments, a touch-screen solution display screen 141, 145, may be used as well as a smaller e-ink system. Preferably, the display screen 141, 145, will be able to convert to or display a virtual keyboard that may be touch operated, providing the user 101 a mechanism for inputting data. The virtual keyboard of the display screen 141, 145, will also serve to move through the file system of a node 130, 131, 132. For example, a user 101 might create standard messages prior to beginning a mission. This would be a reasonable way to report location and arrival at coordinating points or other control measures. In this way the user 101 is able to select and instantly send the completed message via their node 130, 131, 132, when appropriate.

In some embodiments, the system 100 may use multiple configurations/node 130, 131, 132, types and roles which may use commercially available computing devices, such as a Raspberry Pi 4 and a Pi Zero (W). In further embodiments, the system 100 may use one or more nodes 130, 131, 132, which may be or may comprise Application Specific Integrated Circuits (ASIC). As mentioned earlier, the trade space is currently believed to be power consumption—power generation—compute requirements. The hardware of nodes 130, 131, 132, employed by the system 100 may comprise any suitable computing device, that may be selected as a function of a mission requirement determining a specific configuration (e.g., primary, secondary or tertiary). For example, an Nvidia Jetson may be employed to provide a configuration with an on-board GPU. A GPU would be desirable in cases where numerous parallel processes are required. For example, when paired with a camera a system that employs image recognition may be deployed in a security or rescue operation. As discussed above, some embodiments may initially include a user and sensor type of secondary node 132 with further configurations and components added later, as needed. This enables the development of the foundation of the capability before further expanding to service principals and other configurations. As an operational example, a geographic area may be seeded with these tiny compute nodes 132 in order to create a networked compute fabric prior to an operation, distributing hundreds or thousands of compute nodes 132 as required to compose a decentralized computer.

In preferred embodiments, the system 100 may use two or more different configuration types (e.g., primary, secondary, tertiary configurations) along with different roles. A configuration is mission-requirement specific while a role determines what a user is able to do. For example, a use-case with three different configurations and three roles could be a human user, a service principal, and a sensor. In this example, user 101 is an individual, a human user that will have read and write permission. They preferably may have a primary node 131 (optionally a primary node 131 and/or a secondary node 132) attached to their individual equipment. A service principal may be a platform or system having a secondary node 132 that only needs to read from the distributed ledger 112, 113. This may be a configuration that is an embedded system on a platform. This may be associated with an Artificial Intelligence-based (AI) system or other external system. Preferably, a secondary node 132 may comprise an unmanned sensor 122, such as found on an unmanned vehicle, beacon, etc., may not need to read from the distributed ledger 112, 113, so its role may only allow it to submit transactions, to write to the distributed ledger 112, 113. This might be a third configuration that is a small, autonomous system, maybe a robotic unmanned sensor 122. Another example might be a navigation beacon unmanned sensor 122 whose position can never be changed since it is locked in the distributed ledger 112, 113.

In preferred embodiments, a node 130, such as a primary 131 and a secondary node 132, may include a power source 142, 146, which may provide electrical power to any component that may require electrical power. For example, a primary node 131 may have a power source 142 that comprises a Real Graphene Power Bank (5000 mAh), and a secondary node 132 may have a power source 146 that comprises a Real Graphene Power Bank (5000 mAh). In further preferred embodiments, a power source 142, 146, may be rechargeable and may comprise a rechargeable battery, such as a graphene battery, a lithium-ion battery, a nickel cadmium battery, a capacitor, a super capacitor, or any other suitable type of rechargeable power storage device or method. In further embodiments, a power source 142, 146, may comprise an alkaline battery, a lead-acid battery, a fuel cell, or any other type of electricity storing and/or releasing device. In still further embodiments, a power source 142, 146, may comprise a power cord, kinetic or piezo electric battery charging device, and/or inductive charging or wireless power receiver. In further embodiments, a node 130, such as a primary 131 and a secondary node 132, may include a power distributor 143 which may be configured to control the recharging of a power source 142, 146, discharging of a power source 142, 146, and/or distribution of power to one or more components of a node 130 that may require electrical power.

In preferred embodiments, a node 130, such as a primary 131 and a secondary node 132, may include a power charging module 144, 147, which may be configured to provide and control the recharging of a rechargeable power source 142, 146. For example, a primary node 131 may have a power charging module 144 that comprises a Goal Zero Nomad 20 (20 W solar panel), and a secondary node 132 may have a power charging module 147 that comprises a Goal Zero Nomad 20 (20 W solar panel). In some embodiments, a charging module 144, 147, may comprise a solar cell or photovoltaic cell 148, 149, a power cord, kinetic or piezo electric battery charging device, and/or inductive charging or wireless power receiver. In preferred embodiments, a node 130, such as a primary 131 and a secondary node 132, may be powered by a rechargeable power source 142, 146, that is recharged by a power charging module 144, 147, having a photovoltaic cell 148, 149.

In preferred embodiments, one or more components of the system, such as nodes 10, 131, 132, may include a power charging module 144, 147, that is able to recharge any power consumed through normal use, such as a Pi Juice Pi Hat-UPS. Normal use is considered to be 60 messages received or sent within a twenty-four-hour period. In further preferred embodiments, the system 100 may use nodes 10, 131, 132, and components that have the ability to operate for a week or greater without having to change a battery power source 142, 146, under normal use.

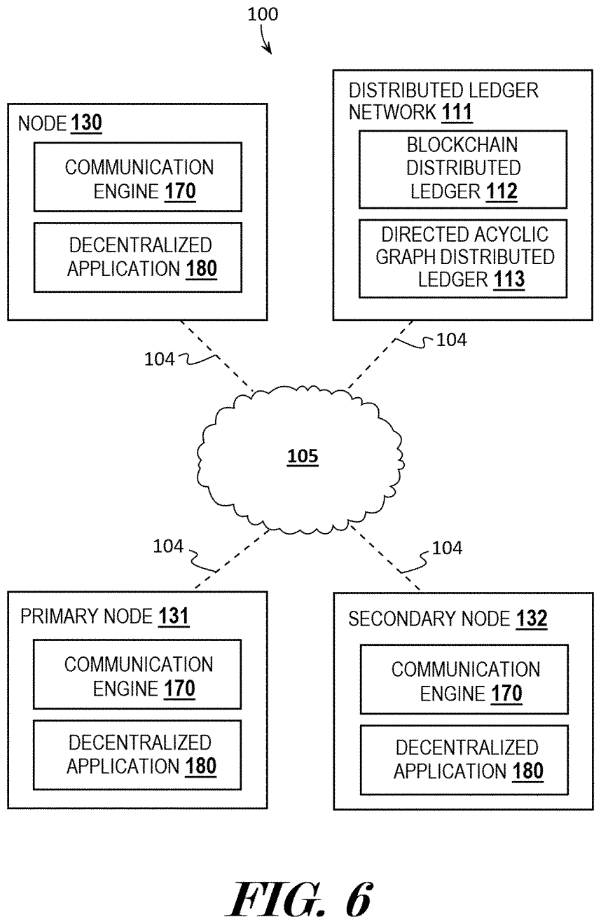

Referring now to FIG. 6, a block diagram showing some software rules engines which may be found in a system 100 and which may optionally be configured to run on one or more nodes 130, 131, 132, according to various embodiments described herein are illustrated. The engines 170, 180, may enable nodes 130, 131, 132, to read, write, or otherwise access data in the distributed ledger 112, 113, of the distributed ledger network 111. Additionally, the engines 170, 180, may be in electronic communication so that data may be readily exchanged between the engines 170, 180. Preferably, a plurality of nodes 130, 131, 132, of the distributed ledger network 111 may maintain the distributed ledger 112, 113, which may preferably comprise a blockchain type of distributed ledger 112 or a directed acyclic graph type of distributed ledger 113. One or more of the engines 151, 152, 153, may read, write, or otherwise access data in the blockchain database(s) 113 of the system 100. It should be understood that the functions attributed to the engines 170, 180, described herein are exemplary in nature, and that in alternative embodiments, any function attributed to any engine 170, 180, may be performed by one or more other engines 170, 180, or any other suitable processor logic.

In some embodiments, the communication engine 170 may comprise or function as communication logic stored in the memory 155 which may be executable by the processor 151 of a node 130, 131, 132, and which may be configured to govern electronic communication between nodes 130, 131, 132. Data from other nodes 130, 131, 132, may be received by the communication engine 170, preferably via LoRa and/or 5G wireless communication methods and protocols, which may then electronically communicate the data to a decentralized application 180 running on the node 130, 131, 132. Likewise, data from a decentralized application 180 running on the node 130, 131, 132, may be received by the communication engine 170 which may then electronically communicate the data to one or more other nodes 130, 131, 132, on the network 105. In some embodiments, the communication engine 170 may govern the electronic communication by initiating, maintaining, reestablishing, and terminating electronic communication between one or more nodes 130, 131, 132. In further embodiments, the communication engine 170 may control the radio 153 or network interface of a node 130, 131, 132, to send and receive data to and from one or more other nodes 130, 131, 132, through a network connection 104 over the network 105.

In some embodiments, the communication engine 170 may comprise or function as input logic stored in the memory 155 which may be executable by the processor 151 of a node 130, 131, 132. The communication engine 170 may receive input from the user 101, preferably through an I/O interface 152, such as a display screen 141, 145, keyboard, etc., and the input may comprise information populating a message from the user 101 to one or more other users 101 and/or or any other information which the user 101 desires to input into the system 100. In preferred embodiments, the communication engine 170 may comprise or function as an identity management service which may be responsible for on-boarding configuration/nodes 130, 131, 132, and assigning role-based permissions to 130, 131, 132, of users 101.

In some embodiments, the communication engine 170 may comprise or function as display logic stored in the memory 155 which may be executable by the processor 151 of a node 130, 131, 132. The communication engine 170 may display to the user 101, via a display screen 141, 145, of the node 130, 131, 132, information of one or more messages from one or more other users 101 to that user 101, and any other information which may be output by the system 100 that the user 101 is credentialled to access.

A decentralized application 180 may comprise or function as decentralized logic stored in the memory 155 which may be executable by the processor 151 of a node 130, 131, 132. Preferably, each node 130, 131, 132, may comprise a decentralized application 180, and the decentralized application 180 may read, manage, and/or perform data transactions on the blockchain database 113 of the node 112. In preferred embodiments, a decentralized application 180 may be run by a processor 151 of one or more primary nodes 151, and may maintain a copy of the distributed ledger 112, 113, on its memory 155 and may thus synchronize transaction data with other nodes 130, 131, 132, containing the distributed ledger in order to implement a blockchain or directed acyclic graph-based transaction processing system 100. In further preferred embodiments, a decentralized application 180 may be run by a processor 151 of one or more secondary nodes 152 which may read a copy of the distributed ledger 112, 113, from one or more other nodes 130, 131, 132, via its network connection 104 to the network 105, thereby allowing the secondary nodes 152 to require less processing power by not having to perform distributed ledger 112, 113, transactions and verifications. A consensus mechanism may be used by a plurality of decentralized applications 180 to validate transactions while cryptographic hashes secure information and provide for unique user addressing without the challenges associated with the configuration, deployment and maintenance of numerous messaging protocols and enterprise services.

Decentralized applications 180 and their “smart contracts” may be built atop the distributed ledger 112, 113, to create transactions automatically when an established condition is met, a feature enabled by a blockchain distributed ledger 112 and/or a directed acyclic graph distributed ledger 113. This capability may be trained to recognize conditions and act according to the parameters of a smart contract. Simple automation coupled with a “smart contract” may be used to provide verifiable, trustworthy reports when events are triggered or to trigger other actions. For example, when a vehicle is stationary in a specific area, that may trigger a reporting indicating that a position has been occupied. Extending this example: Web3applications (i.e., software) executing atop a blockchain protocol distributed ledger 112 may be used to report control measures and execute other simple tasks.

As shown in FIG. 6, the system 100 may comprise a distributed ledger 112, 113, which may be used to confirm and catalog data for decentralized applications 180 running on at least two nodes 130, 131, 132, of the plurality of nodes 130, 131, 132, of the system 100. A distributed ledger 112, 113, may comprise any data and information input to and output by the system 100. The system may use two or more different configuration types (e.g., primary, secondary, tertiary configurations) of distributed ledgers 112, 113, along with different roles.

In preferred embodiments, the system 100 may comprise a distributed ledger 113 that may use a directed acyclic graph (DAG) protocol for data storage and other functions. In further preferred embodiments, the system 100 may comprise a directed acyclic graph distributed ledger 113 that is a permissioned directed acyclic graph distributed ledger 113.

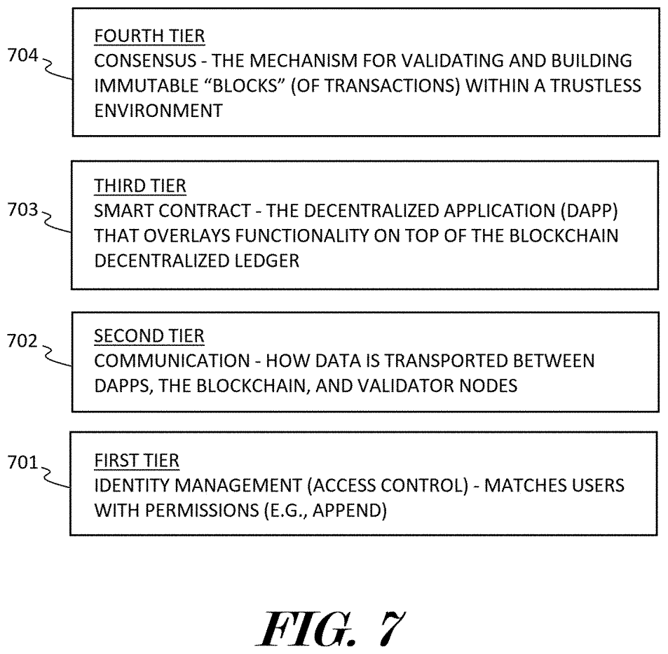

In further preferred embodiments, the system 100 may comprise a distributed ledger 112 that may use a blockchain protocol for data storage and other functions. In further preferred embodiments, the system 100 may comprise a blockchain distributed ledger 112 that is a permissioned blockchain distributed ledger 112. In some embodiments and also referring to FIG. 7, a preferred blockchain protocol for a system 100 using a blockchain distributed ledger 112 may be HyperLedger Fabric, however, other blockchain protocols may be used by the system. HyperLedger Fabric is a private, permissioned blockchain. FIG. 7 shows a block diagram of some of the various example (software) layers or tiers 701, 702, 703, 704, used in HyperLedger Fabric (HLF) according to various embodiments described herein. Note that since this is a private blockchain some type of access and authorization may be required. An identity management service run by a communication engine 170 may be used to perform those tasks. Preferably, the third tier 703 is where specialized applications ‘reside’. Initial decentralized applications (dApp) 180 may include a report dApp that uses formatted mil-standard messages (e.g., Spot report, etc.). The simplest example is a human user 101 interacting with the system 100 through a primary configuration or first tier 701. The user 101 would authenticate through the identity management service run by a communication engine 170 on their node 130, 131, 132. This may be through any number of ways, using numerous protocols (e.g., OAUTH token). The authentication presumes access and then authorizes features based on a role. The second tier 702 in the framework identifies how information is moved between applications and the blockchain distributed ledger 112. The user-facing software of a communication engine 170 preferably uses familiar programming languages and libraries for contemporary web-applications. These libraries handle the movement of data to the third layer 703, the dApp 180 and smart contracts layer. This is, in essence, what would otherwise be the database layer in a contemporary three-tier application architecture. The final layer or fourth tier 704, the consensus mechanism, is responsible for validating transactions and creating the immutable blocks.

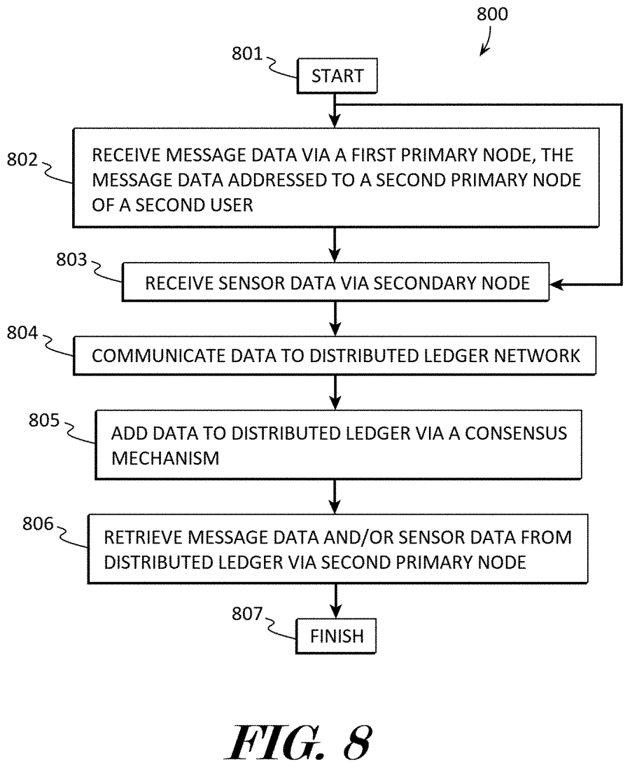

FIG. 8 shows a block diagram of an example of a decentralized information method (“the method”) 800 according to various embodiments described herein. Referring also to the system 100 diagram of FIG. 1, in some embodiments, the method 600 may be used to enable the communication of information between the nodes 130, 131, 132, such as for the communication of messages and data to users 101 of one or more of the nodes 130, 131, 132. One or more steps of the method 800 may be performed by communication engine 170 and/or a decentralized application 180 which may be executed by one or more processors 151 of the one or more nodes 130, 131, 132.

The method 800 may start 801, and the method may include step 802 and/or step 803. In embodiments of the method 800 having both steps 802 and 803, steps 802 and 803 may be performed in any order, including being performed simultaneously.

In step 802, message data may be received from user input of a first user 101A via a first primary node 131A, the message data addressed to a second primary node 131B of a second user 101B. It should be understood that the message data may be addressed to at least one node 130, 131, 132, of the plurality of nodes 130, 131, 132, of the system 100, which may include a second primary node 131B of a second user 101B, and the message data may be addressed to any number of nodes 130, 131, 132, of the plurality of nodes 130, 131, 132, of the system 100. User input may be received from a user 101 via an I/O interface 152 of a node 130, 131, 132, such as touch screen display screen 141, 145, via a communication engine 170 running on the node 130, 131, 132, that is being operated by the user 101. For example, a user 101 might create message data which may comprise location data and arrival time data at coordinating points or other control measures.

In step 803, sensor data may be received from one or more secondary nodes 132 via a communication engine 170 running on the one or more secondary nodes 132.

In step 804, the data of step 802 and/or 803 may be communicated to a distributed ledger network 111 of the system 100 via the communication engine 170 of the node(s) 130, 131, 132, that received the data of step 802 and/or 803. Optionally, message data of step 802 may be encrypted by a communication engine 170 and/or by a decentralized application 180 running on a node 130, 131, 132, before it is added to the distributed ledger 112, 113. Optionally, sensor data of step 803 may be encrypted by a communication engine 170 and/or by a decentralized application 180 running on a node 130, 131, 132, before it is added to the distributed ledger 112, 113.

In step 805, message data and/or sensor data of step 804 may be added to the distributed ledger 112, 113, via a consensus mechanism by a plurality of decentralized applications 180 running on the plurality of nodes 130, 131, 132, of the system 100.

In step 806, message data and/or sensor data of step 805 may be retrieved from the distributed ledger via a second primary node 131B and one or more other nodes 130, 131, 132, that the data was addressed to or which are otherwise authorized to access the data via a communication engine 170 and/or decentralized application 180 running on the respective second primary node 131B and one or more other respective nodes 130, 131, 132.

After step 806, the method 800 may finish 807.

Referring to FIGS. 1 and 8, an example real-world scenario of using the system 100 and method 800 will now be described. In step 803, an unmanned vehicle 122 having a sensor secondary node 132 identifies a target 66 and communicates the sensor data (images, location coordinates, etc.) to the distributed ledger network 111 (step 804) and the system 100 may append the sensor data to the distributed ledger 112, 113, of the network 111 as a transaction having target 66 information that is readable for all permissioned users 101 via their respective node 130, 131, 132, (step 805). The decentralized application(s) 180 read the transaction and provide to other systems (step 806). Optionally, a manned vehicle 121 may append information to the initial report via their 131. A first user 101A reads the initial and subsequent report, begins making/changing plans, and the first user 101A sends plan/changes to the distributed ledger network 111, via their first primary node 131A, as message data addressed to a second primary node 131B of a second user 101B in step 802 which is then communicated to distributed ledger network 111 in step 804 where it is added to the distributed ledger 112, 113, via a consensus mechanism performed by the plurality of nodes 130, 131, 132. The second primary node 131B of the second user 101B may then retrieve the message data and/or sensor data that is addressed to them from distributed ledger 112, 113, where it may be displayed to the second user 101B on the display screen 141 of their node 131B.

This is just one of many possible use scenarios for the system 100 and method 800 of the present invention which may be configured for employing exponential technologies in mission critical, mission information systems or decentralized information systems that operate at the edge. The present invention employs distributed ledger technology, to create a secure, trustless communications, operations and mission command system. In preferred embodiments, the decentralized information system 100 may employ a blockchain and/or a DAG, along with edge computing, advanced wireless networking and emerging power generation and storage capabilities (e.g., solar cells and graphene batteries) to provide the foundation for a decentralized, IoT-like, mission information system. The system 100 preferably employs nodes 130, 131, 132, having emerging battery/power cell technology and energy efficient, single board computers along with Distributed Ledger Technology (DLT) to create a trustless fabric for secure information exchange that does not rely on fixed facilities and commercial power.

While the previous example has focused on a specific national security implementation, the system 100 and method 800 of the present invention have utility in other sectors including law enforcement, emergency response and even as the basis for a public decentralized, IT fabric. Preferably, the system 100 may include the harnessing of solar powered, inexpensive compute at scale along with networking and secure, decentralized storage and blockchain oracles which enables progress towards the metaverse, offering an alternative that imagines a large, decentralized collective that sells service and access for a minimal cost, to cover their costs, versus a small number of centralized, commercial service providers whose business-model requires that they generate profits for their shareholders.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g., through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and WIFI networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A decentralized information system, the system including:
a plurality of nodes that are in electronic communication, wherein the plurality of nodes includes a first primary node operable by a first user, a second primary node operable by a second user, and a secondary node, wherein the secondary node comprises an unmanned sensor that is configured to record sensor data;
a plurality of decentralized applications, wherein each node of the plurality of nodes is running one decentralized application of the plurality of decentralized applications;
a blockchain distributed ledger used to confirm and catalog data for the decentralized applications; and
a message data generated by the first primary node and addressed to the second primary node, the message data added to the distributed ledger via a consensus mechanism performed by the decentralized applications.

2. The system of claim 1, wherein the message data is encrypted before it is added to the blockchain distributed ledger.

3. The system of claim 1, wherein the sensor data is added to the blockchain distributed ledger via a consensus mechanism performed by the decentralized application.

4. The system of claim 3, wherein the sensor data is encrypted before it is added to the blockchain distributed ledger.

5. The system of claim 1, wherein at least one of the first primary node, second primary node, and secondary node is a single-board computer.

6. The system of claim 1, wherein at least one of the first primary node, second primary node, and secondary node is a computer that contains separated processor, data store, and memory.

7. The system of claim 1, wherein at least one of the first primary node, second primary node, and secondary node is powered by a rechargeable power source that is recharged by a power charging module having a photovoltaic cell.

8. The system of claim 1, wherein the plurality of nodes is in electronic communication via a mesh network.

9. The system of claim 1, wherein at least two nodes of the plurality of nodes are in electronic communication using at least one of a LoRa and a 5G wireless communication method and protocol.

10. The system of claim 1, wherein the blockchain distributed ledger is a permissioned blockchain distributed ledger.

11. A decentralized information system, the system including:
a plurality of nodes that are in electronic communication, wherein the plurality of nodes includes a first primary node operable by a first user, a second primary node operable by a second user, and a secondary node, wherein the secondary node comprises an unmanned sensor that is configured to record sensor data;
a plurality of decentralized applications, wherein each node of the plurality of nodes is running one decentralized application of the plurality of decentralized applications;
a directed acyclic graph distributed ledger maintained by the decentralized applications; and
a message data generated by the first primary node and addressed to the second primary node, the message data added to the distributed ledger via a consensus mechanism performed by the decentralized application.

12. The system of claim 11, wherein the message data is encrypted before it is added to the directed acyclic graph distributed ledger.

13. The system of claim 11, wherein the sensor data is added to the directed acyclic graph distributed ledger via a consensus mechanism performed by the decentralized application.

14. The system of claim 13, wherein the sensor data is encrypted before it is added to the directed acyclic graph distributed ledger.

15. The system of claim 11, wherein at least one of the first primary node, second primary node, and secondary node is a single-board computer.

16. The system of claim 11, wherein at least one of the first primary node, second primary node, and secondary node is a computer that contains separated processor, data store, and memory.

17. The system of claim 11, wherein at least one of the first primary node, second primary node, and secondary node is powered by a rechargeable power source that is recharged by a power charging module having a photovoltaic cell.

18. The system of claim 11, wherein the plurality of nodes is in electronic communication via a mesh network.

19. The system of claim 11, wherein at least two nodes of the plurality of nodes are in electronic communication using at least one of a LoRa and a 5G wireless communication method and protocol.

20. The system of claim 11, wherein the directed acyclic graph distributed ledger is a permissioned directed acyclic graph distributed ledger.
